(19) United States
(12) Patent Application Publication
(10) Pub. No.: US 2007/0265932 A1
(43) Pub. Date: Nov. 15, 2007

(54) Apparatus for providing rights resale function and method thereof

(75) Inventors: Bum-jin Im, Yongin-si (KR); Bae-eun Jung, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/543,069

(22) Filed: Oct. 5, 2006

(30) Foreign Application Priority Data
Dec. 22, 2005 (KR) 10-2005-0128004

(51) Int. Cl. G06Q 30/00

(52) U.S. Cl. 705/26

(57) ABSTRACT

An apparatus for providing a rights resale function and a method thereof are provided, in which a rights object to execute content can be freely transferred and shared among users on the intervention of a rights issuer. The apparatus for providing a rights resale function applied to a system which includes a rights acquisition agent and a rights issuer, includes a storage unit for storing a content related rights object, a token generation unit for generating a token for rights resale such as a token for reselling rights to obtain an issuance of the content related rights object from the rights issuer, with reference to the rights object from the storage unit, and a transmission/reception unit for transmitting the token for rights resale from the token generation unit to the rights acquisition agent.

### CROSS-REFERENCE TO RELATED APPLICATIONS

This application claims the benefit under 35 U.S.C. §119 of Korean Patent Application No. 10-2005-128004, filed Dec. 22, 2005, in the Korean Intellectual Property Office, the entire disclosure of which is incorporated herein by reference.

### BACKGROUND OF THE INVENTION

1. Field of the Invention

The present invention relates to an apparatus for providing a rights resale function and a method thereof. More particularly, the present invention relates to an apparatus for providing a rights resale function and a method thereof capable of reselling part or all of a user's rights to content.

2. Description of the Related Art

At the initial stage, many companies provide content services on the basis of copy prevention technology. Recently, digital rights management (DRM) based on the flexibility and convenience of a user's rights object (RO) has been gradually introduced.

This DRM technology basically permits free distribution of encrypted content among users, but permits the user's execution of the corresponding content only after the user's purchase of the corresponding rights object. Through this free distribution of content, a user can transmit favorite content to his/her acquaintances. In addition, the free distribution of content extends the use of quality content and effects the circulation and advertisement of content.

In order to execute the encrypted content, a content receiver requires the rights object. That is, although a user has received the encrypted content from another user, he/she cannot execute the content if he/she has not purchased the rights object.

Conventionally, since it is intended that a content provider and content license for executing the content are managed in the same server, license information exists only in the server. Accordingly, in order to share the license among users, the server's participation is inevitably required. In addition, in order to transfer the license, a server's pre-authentication process should be performed. That is, in order to transfer the content license, a transferor should request the transfer to the server and send an encryption key, which is received from the server in response to the request, to a transferee, so that the transferee can take an authentication process through the encryption key to use the content. This process is complicated and causes inconvenience to the users.

Accordingly, a need exists for a system and method for providing a rights resale function and a method thereof.

### SUMMARY OF THE INVENTION

Embodiments of the present invention have been developed in order to substantially solve the above and other problems associated with the conventional arrangement and provide the objectives listed below. An aspect of embodiments of the present invention is to provide an apparatus for providing a rights resale function and a method thereof, in which a rights object to execute content can be freely transferred and shared among users on the intervention of a rights issuer.

The foregoing and other objects and advantages are substantially realized by providing an apparatus for providing a rights resale function applied to a system that comprises a rights acquisition agent and a rights issuer, according to embodiments of the present invention, which comprises a storage unit for storing a content related rights object, a token generation unit for generating a token for rights resale such as a token for reselling rights to obtain an issuance of the content related rights object from the rights issuer, with reference to the rights object from the storage unit, and a transmission/reception unit for transmitting the token for rights resale from the token generation unit to the rights acquisition agent.

According to another aspect of embodiments of the present invention, a method of providing a rights resale function applied to a system that comprises a rights resale agent, a rights acquisition agent, and a rights issuer is provided, which comprises generating a token for rights resale such as a token for reselling rights to obtain an issuance of a content related rights object from the rights issuer, with reference to the rights object from the rights resale agent, and transmitting the token for rights resale to the rights acquisition agent.

According to still another aspect of embodiments of the present invention, a method of providing a rights resale function applied to a system that comprises a rights resale agent, a rights acquisition agent, and a rights issuer is provided, which comprises receiving protected content and a token for rights resale from the rights resale agent, requesting a rights object to the rights issuer by using the token for rights resale, receiving the rights object from the rights issuer, and releasing a locking state of the protected content by using the received rights object.

### BRIEF DESCRIPTION OF THE DRAWINGS

The above aspects and features of embodiments of the present invention will become more apparent by describing certain exemplary embodiments of the present invention with reference to the accompanying drawings, in which:

FIG. 1 is a block diagram illustrating the construction of an exemplary apparatus for providing a rights resale function according to an embodiment of the present invention;

FIG. 2 is a flowchart illustrating an exemplary method of providing a rights resale function according to an embodiment of the present invention;

FIG. 3 is a flowchart illustrating an exemplary method of providing a rights resale function according to another embodiment of the present invention; and

FIGS. 4 to 7 are exemplary views illustrating examples of systems to which the method of providing a rights resale function according to exemplary embodiments of the present invention is applied.

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the annexed drawings. In the drawings, the same elements are denoted by the same reference numerals throughout the drawings. In the following description, detailed descriptions of known functions and configurations incorporated herein have been omitted for conciseness and clarity.

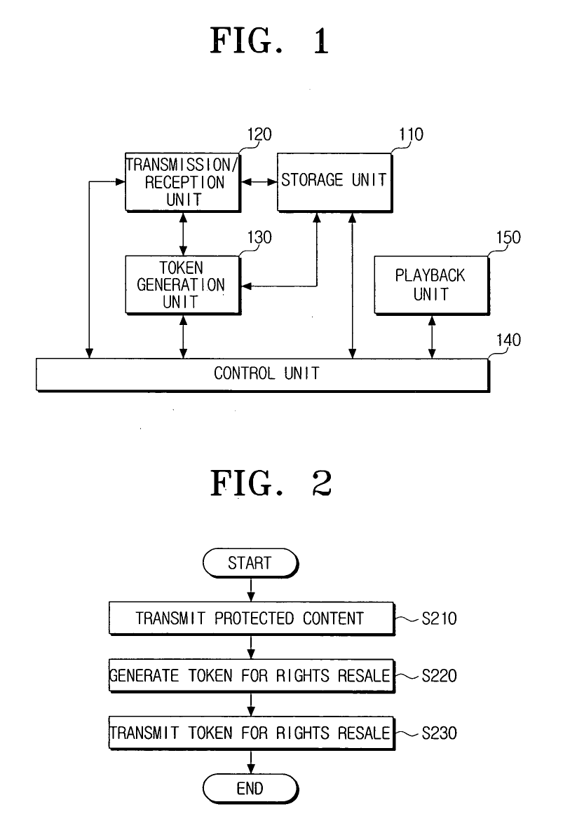

FIG. 1 is a block diagram illustrating the construction of an exemplary apparatus for providing a rights resale function according to an embodiment of the present invention.

The apparatus for providing a rights resale function according to an embodiment of the present invention comprises a storage unit 110, a transmission/reception unit 120, a token generation unit 130, a control unit 140, and a playback unit 150.

The apparatus for providing a rights resale function according to embodiments of the present invention may be a digital rights management (DRM) agent, but is not limited thereto.

The storage unit 110 serves to store a content related rights object given from a rights issuer, and the token generation unit 130 provides the stored content related rights object. Here, the storage unit 110 can store content provided from a content provider (not illustrated), output the rights object to the control unit 140, and store a rights object modified by the control unit 140. The content provided from the content provider may be a protected content, but is not limited thereto.

The transmission/reception unit 120 receives an input of a token for rights resale from the token generation unit 130, transmits the input token for rights resale to a acquisition agent (not illustrated), and receives the protected content from the content provider to transmit the received content to the storage unit 110. The transmission/reception unit 120 also receives the content from the storage unit 110, and transmits the received content to a rights resale agent (not illustrated). Here, the rights acquisition agent may be a DRM agent, but is not limited thereto. Also, the transmission/reception unit 120 may transmit the token for rights resale through a local limited channel, but is not limited thereto. It is apparent that even if the local limited channel is not used, the same effect can be achieved in the case of using a certificate.

Here, the token for rights resale will now be described in greater detail.

The token for rights resale may be a token reselling rights to receive an issue of the content related rights object from a rights issuer (not illustrated), and this token for rights resale may comprise authentication information and use information.

Here, the authentication information may comprise a public key held by the apparatus for providing a rights resale function according to embodiments of the present invention, a public key of the rights acquisition agent, a nonce, a transaction ID, and so forth.

In addition, the token for rights resale may further comprise values obtained by signing the authentication information and the use information with a private key held by the apparatus for providing a rights resale function.

The token generation unit 130 receives the rights object from the storage unit 110, generates the token for rights resale with reference to the provided rights object, and outputs the generated token for rights resale to the transmission/reception unit 120.

The control unit 140 receives the rights object from the storage unit 110, modifies the provided rights object with reference to the token for rights resale transmitted from the transmission/reception unit 120, and outputs the modified rights object to the storage unit 110. Also, the control unit 140 receives an input of the protected content from the storage unit 110, releases the locking state of the protected content using the rights object provided from the storage unit 110, and outputs the content of which the locking state has been released to the playback unit 150.

The playback unit 150 receives and processes the content of which the locking state has been released from the control unit 140, and outputs the content processed in a form that can be viewed (or used in any manner) by a user.

Referring to FIG. 1, an exemplary operation of the apparatus for providing a rights resale function according to an embodiment of the present invention will now be described in greater detail.

First, a protected content is transmitted to the rights acquisition agent that is a DRM agent through the transmission/reception unit 120.

Thereafter, if a request for a token for rights resale is received from the rights acquisition agent through the transmission/reception unit 120, a token for rights resale is generated by the token generation unit 130, with reference to a rights object provided from the storage unit 110. Here, a public key of the acquisition agent may be received simultaneously with the request for the token for rights resale.

Then, the generated token for rights resale is transmitted to the rights acquisition agent through the transmission/reception unit 120. Here, the token for rights resale may be a token for reselling rights to obtain an issuance of the content related rights object from the rights issuer (not illustrated), and may comprise authentication information and use information. The authentication information may comprise a public key held by the apparatus for providing a rights resale function according to embodiments of the present invention, a public key of the rights acquisition agent, a nonce, a transaction ID, and so forth. Also, the token for rights resale may further comprise values obtained by signing the authentication information and the use information with a private key held by the apparatus for providing a rights resale function.

Thereafter, if an acknowledgement (ACK) signal acknowledging the reception of the token for rights resale is received from the rights acquisition agent through the transmission/reception unit 120, the rights object stored in the storage unit 110 is modified by the control unit 140. Here, the nonce transmitted as the token for the rights resale may be signed with a private key of the rights acquisition agent and transmitted simultaneously with the ACK signal.

If the rights object stored in the storage unit 110 is modified, a finish signal is transmitted to the rights acquisition agent through the transmission/reception unit 120. Here, the value of the nonce, which has been signed with the private key of the rights acquisition agent, may be signed again with a private key of the apparatus for providing a rights resale function according to embodiments of the present invention and transmitted simultaneously with the finish signal.

Now, an exemplary method of providing a rights resale function according to an embodiment of the present invention will be described with reference to FIG. 2, which is a flowchart illustrating a method of providing a rights resale function according to an embodiment of the present invention.

The rights resale agent transmits the protected content received from the content provider to the rights acquisition agent at step (S210).

Then, the rights resale agent generates a token for rights resale with reference to its own rights object at step (S220). Here, step (S210) and step (S220) may be successively performed as shown, or may be performed in parallel.

Here, the token for rights resale will now be described in greater detail.

The token for rights resale may be a token for reselling rights to obtain an issuance of the content related rights object from the rights issuer (not illustrated), and may comprise authentication information and use information.

The authentication information may comprise a public key held by the apparatus for providing a rights resale function according to embodiments of the present invention, a public key of the rights acquisition agent, a nonce, a transaction ID, and so forth.

Also, the token for rights resale may further comprise values obtained by signing the authentication information and the use information with a private key held by the apparatus for providing a rights resale function.

Thereafter, the rights resale agent transmits the generated token for rights resale to the rights acquisition agent at step (S230). Here, the rights resale agent may transmit the token for rights resale through a local limited channel, but is not limited thereto.

Then, the rights acquisition agent can modify the stored rights object with reference to the token for rights resale (not illustrated).

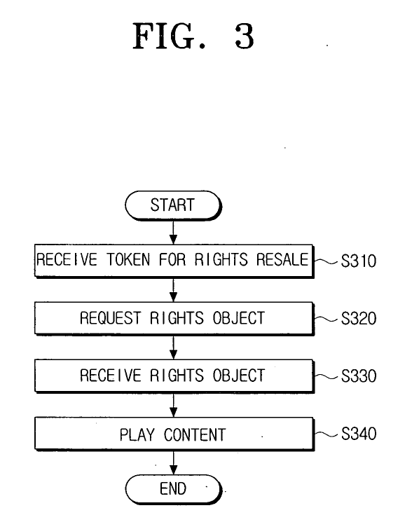

Now, an exemplary method of providing a rights resale function according to another embodiment of the present invention will be described with reference to FIG. 3, which is a flowchart illustrating a method of providing a rights resale function according to another embodiment of the present invention.

The rights acquisition agent receives a protected content and a token for rights resale from the rights resale agent at step (S310).

Here, the token for rights resale will now be described in greater detail.

The token for rights resale may be a token for reselling rights to obtain an issuance of the content related rights object from the rights issuer (not illustrated), and may comprise authentication information and use information.

The authentication information may comprise a public key held by the apparatus for providing a rights resale function according to embodiments of the present invention, a public key of the rights acquisition agent, a nonce, a transaction ID, and so forth.

Also, the token for rights resale may further comprise values obtained by signing the authentication information and the use information with a private key held by the apparatus for providing a rights resale function.

Then, the rights acquisition agent requests the rights object to the rights issuer using the token for rights resale at step (S320).

Thereafter, the rights acquisition agent receives the rights object from the rights issuer at step (S330).

Then, the rights acquisition agent releases the locking state of the protected content using the received rights object, and then plays the content of which the locking state has been released according to the use information included in the token for rights resale at step (S340).

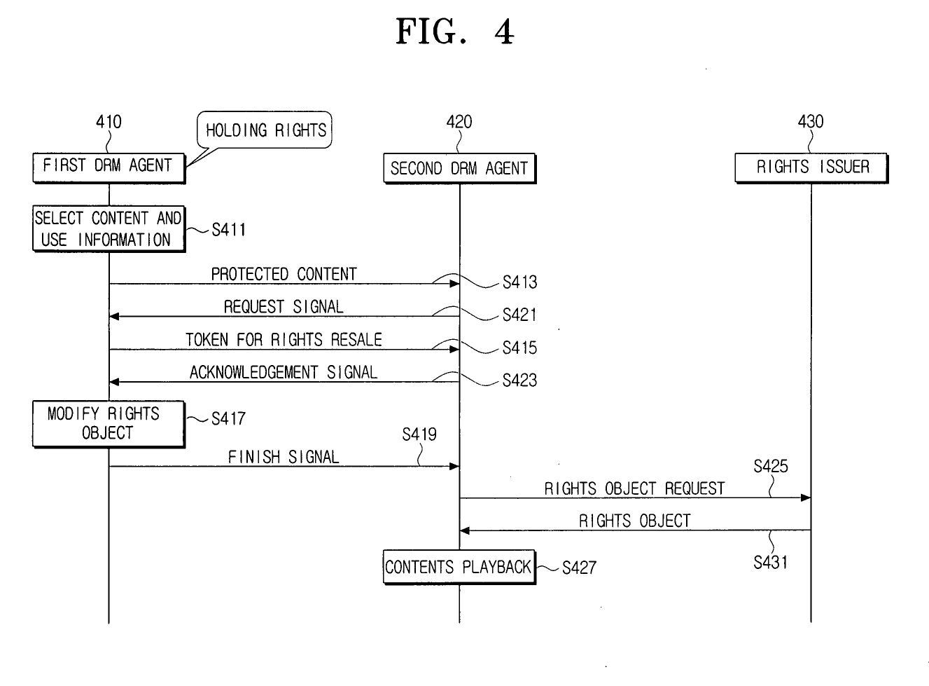

FIGS. 4 to 7 are exemplary views illustrating examples of systems to which the method of providing a rights resale function according to embodiments of the present invention is applied. With reference to FIGS. 4 to 7, the method of providing a rights resale function according to embodiments of the present invention will now be described in greater detail.

First, with reference to FIG. 4, a user who uses the first DRM agent 410, which is an example of a rights resale agent, selects content to be resold to the second DRM agent 420, which is an example of a rights acquisition agent, and use information, at step (S411).

Then, the first DRM agent 410 transmits a protected content provided from a content provider to the second DRM agent 420 at step (S413).

Then, the first DRM agent 410 receives a request signal for a token for rights resale from the second DRM agent 420 at step (S421). Here, a public key of the second DRM agent 420 may be received simultaneously with the request for the token for rights resale.

Thereafter, the first DRM agent 410 generates the token for rights resale with reference to its own rights object, and transmits the generated token to the second DRM agent 420 at step (S415). Here, the token for rights resale may be a token for reselling rights to obtain an issuance of the content related rights object from a rights issuer 430, and may comprise authentication information and use information. The authentication information may comprise a public key held by the first DRM agent 410, a public key of the second DRM agent 420, a nonce, a transaction ID, and so forth. Also, the token for rights resale may further comprise values obtained by signing the authentication information and the use information with a private key held by the first DRM agent 410.

Then, the first DRM agent 410 receives an acknowledgement (ACK) signal acknowledging the reception of the token for rights resale from the second DRM agent 420 at step (S423). Here, the nonce transmitted as the token for the rights resale may be signed with a private key of the second DRM agent 420 and transmitted simultaneously with the ACK signal.

Then, the first DRM agent 410 modifies the rights object stored therein at step (S417).

Then, the first DRM agent 410 transmits a finish signal to the second DRM agent 420 at step (S419). Here, the value of the nonce, which has been signed with the private key of the second DRM agent 420, may be signed again with a private key of the first DRM agent 410 and transmitted simultaneously with the finish signal.

Thereafter, the second DRM agent 420 transmits the token for rights resale and a rights object request signal to the rights issuer 430 at step (S425). Here, the second DRM agent 420 may receive values obtained by signing the nonce, which had been received together with the finish signal from the first DRM agent 410, with the private key of the second DRM agent 420 and then signing the signed nonce again with the private key of the first DRM agent 410.

Then, the second DRM agent 420 receives the rights object according to the token for rights resale from the rights issuer 430 at step (S431).

Then, the second DRM agent 420 releases the locking state of the protected content that has been received from the first DRM agent 410 according to the rights object received from the rights issuer 430, and then plays the content at step (S427).

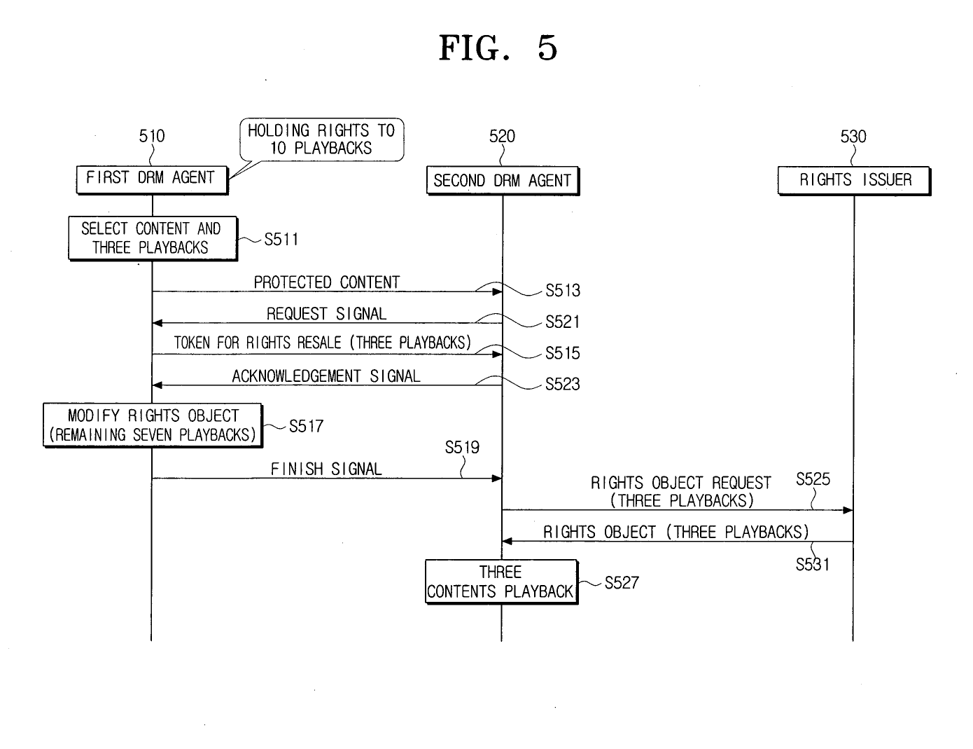

FIG. 5 is an exemplary view illustrating an example of a system to which the method of providing a rights resale function according to embodiments of the present invention is applied. In particular, a method of distributing the number of playbacks will now be described with reference to FIG. 5.

First, a user who uses the first DRM agent 510, which is an example of a rights resale agent, selects content to be resold to the second DRM agent 520, which is an example of a rights acquisition agent, and the number of playbacks, that is use information, at step (S511). Here, the number of playbacks can be selected in the range of the rights object held by the first DRM agent 510. For example, if the first DRM agent holds rights to ten content playbacks, rights to three content playbacks can be selected as the use information.

Then, the first DRM agent 510 transmits a protected content provided from a content provider to the second DRM agent 520 at step (S513).

Then, the first DRM agent 510 receives a request signal for a token for rights resale from the second DRM agent 520 at step (S521). Here, a public key of the second DRM agent 520 may be received simultaneously with the request for the token for rights resale.

Thereafter, the first DRM agent 510 generates the token for rights resale with reference to its own rights object, and transmits the generated token to the second DRM agent 520 at step (S515). Here, the token for rights resale may be a token for reselling rights to obtain an issuance of the content related rights object from a rights issuer 530, and may comprise authentication information and the number of playbacks (e.g., three playbacks). The authentication information may comprise a public key held by the first DRM agent 510, a public key of the second DRM agent, a nonce, a transaction ID, and so forth. Also, the token for rights resale may further comprise values obtained by signing the authentication information and the number of playbacks with a private key held by the first DRM agent 510.

Then, the first DRM agent 510 receives an acknowledgement (ACK) signal acknowledging the reception of the token for rights resale from the second DRM agent 520 at step (S523). Here, the nonce transmitted as the token for the rights resale may be signed with a private key of the second DRM agent 520 and transmitted simultaneously with the ACK signal.

Then, the first DRM agent 510 modifies the rights object stored therein at step (S517). For example, the first DRM agent may modify the rights object from ten content playbacks to seven content playbacks.

Then, the first DRM agent 510 transmits a finish signal to the second DRM agent 520 at step (S519). Here, the value of the nonce, which has been signed with the private key of the second DRM agent 520, may be signed again with a private key of the first DRM agent 510 and transmitted simultaneously with the finish signal.

Thereafter, the second DRM agent 520 transmits the token for rights resale and a rights object request signal to the rights issuer 530 at step (S525). Here, the second DRM agent 520 may receive values obtained by signing the nonce, which had been received together with the finish signal from the first DRM agent 510, with the private key of the second DRM agent 520 and then signing the signed nonce again with the private key of the first DRM agent 510.

Then, the second DRM agent 520 receives the rights object according to the token for rights resale from the rights issuer 530 at step (S531).

Then, the second DRM agent 520 releases the locking state of the protected content that has been received from the first DRM agent 510 according to the rights object received from the rights issuer 530, and then can play the content three times at step (S527).

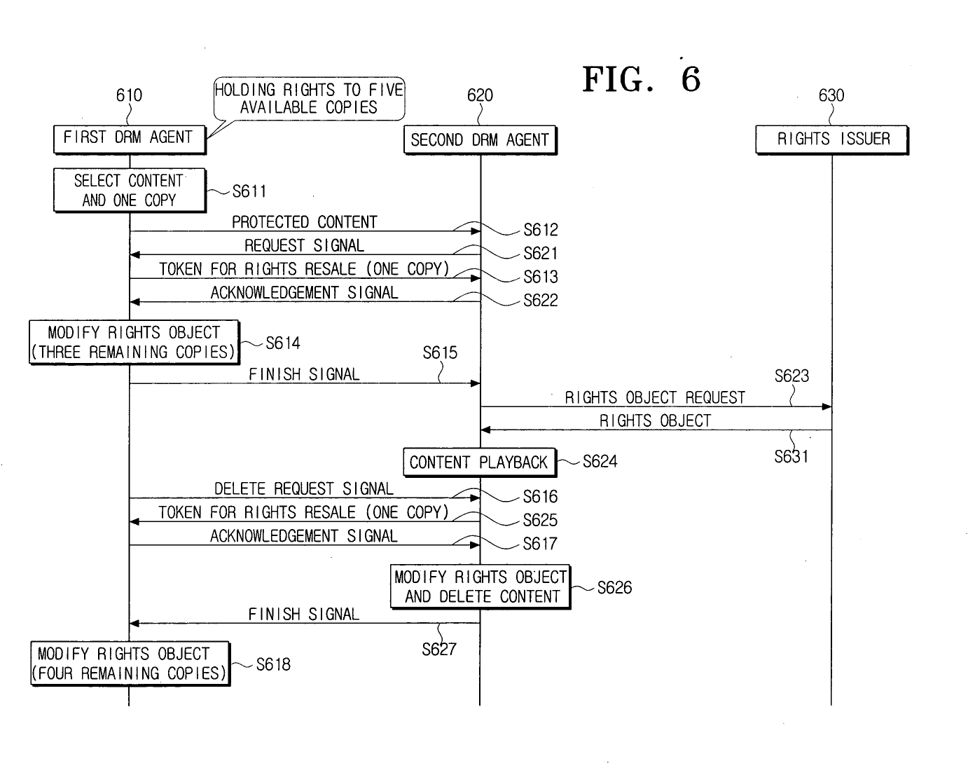

FIG. 6 is an exemplary view illustrating an example of a system to which the method of providing a rights resale function according to embodiments of the present invention is applied. In particular, a method of distributing rights to copy and then withdrawing the distributed rights will now be described with reference to FIG. 6.

First, a user who uses the first DRM agent 610, which is an example of a rights resale agent, selects content to be resold to the second DRM agent 620, which is an example of a rights acquisition agent, and the number of available copies, that is use information, at step (S611). Here, the number of available copies can be selected in the range of the rights object held by the first DRM agent 610. For example, if the first DRM agent holds rights to five available copies, rights to four available copies can be selected as the use information.

Then, the first DRM agent 610 transmits a protected content provided from a content provider to the second DRM agent 620 at step (S612).

Then, the first DRM agent 610 receives a request signal for a token for rights resale from the second DRM agent 620 at step (S621). Here, a public key of the second DRM agent 620 may be received simultaneously with the request signal for the token for rights resale.

Thereafter, the first DRM agent 610 generates the token for rights resale with reference to its own rights object, and transmits the generated token to the second DRM agent 620 at step (S613). Here, the token for rights resale may be a token for reselling rights to obtain an issuance of the content related rights object from a rights issuer 630, and may comprise authentication information and the number of available copies (e.g., one copy). The authentication information may comprise a public key held by the first DRM agent 610, a public key of the second DRM agent 620, a nonce, a transaction ID, and so forth. Also, the token for rights resale may further comprise values obtained by signing the authentication information and the number of available copies with a private key held by the first DRM agent 610.

Then, the first DRM agent 610 receives an acknowledgement (ACK) signal acknowledging the reception of the token for rights resale from the second DRM agent 620 at step (S622). Here, the nonce transmitted as the token for the rights resale may be signed with a private key of the second DRM agent 620 and transmitted simultaneously with the ACK signal.

Then, the first DRM agent 610 modifies the rights object stored therein at step (S614). For example, the first DRM agent may modify the number of available copies from four to three.

Then, the first DRM agent 610 transmits a finish signal to the second DRM agent 620 at step (S615). Here, the value of the nonce, which has been signed with the private key of the second DRM agent 620, may be signed again with a private key of the first DRM agent 610 and transmitted simultaneously with the finish signal.

Thereafter, the second DRM agent 620 transmits the token for rights resale and a rights object request signal to the rights issuer 630 at step (S623). Here, the second DRM agent 620 may receive values obtained by signing the nonce, which had been received together with the finish signal from the first DRM agent 610, with the private key of the second DRM agent 620 and then signing the signed nonce again with the private key of the first DRM agent 610.

Then, the second DRM agent 620 receives the rights object according to the token for rights resale from the rights issuer 630 at step (S631).

Then, the second DRM agent 620 releases the locking state of the protected content that has been received from the first DRM agent 610 according to the rights object received from the rights issuer 630, and can then play the content at step (S624).

Thereafter, the second DRM agent 620 receives a delete request signal for a token for rights resale from the first DRM agent 610 at step (S616). Here, a public key of the first DRM agent 610 may be received simultaneously with the delete request signal for the token for rights resale.

Then, the second DRM agent 620 generates the token for rights resale with reference to its own rights object, and transmits the generated token to the first DRM agent 610 at step (S625). Here, the token for rights resale may be a token for reselling rights to obtain an issuance of the content related rights object from a rights issuer 630, and may comprise authentication information and the number of available copies (e.g., one copy). The authentication information may comprise a public key held by the second DRM agent 620, a public key of the first DRM agent 610, a nonce, a transaction ID, and so forth. Also, the token for rights resale may further comprise values obtained by signing the authentication information and the number of available copiers with a private key held by the first DRM agent 610.

Then, the second DRM agent 620 receives an acknowledgement (ACK) signal acknowledging the reception of the token for rights resale from the first DRM agent 610 at step (S617). Here, the nonce transmitted as the token for the rights resale may be signed with a private key of the first DRM agent 610 and transmitted simultaneously with the ACK signal.

Then, the second DRM agent 620 modifies the rights object stored therein, and deletes the content at step (S626). For example, the second DRM agent may delete the copy function and delete the content.

Then, the second DRM agent 620 transmits a finish signal to the first DRM agent 610 at step (S627). Here, the value of the nonce, which has been signed with the private key of the first DRM agent 610, may be signed again with a private key of the second DRM agent 620 and transmitted simultaneously with the finish signal.

Thereafter, the first DRM agent 610 modifies the rights object stored therein at step (S618). For example, the number of available copies may be modified from three to four.

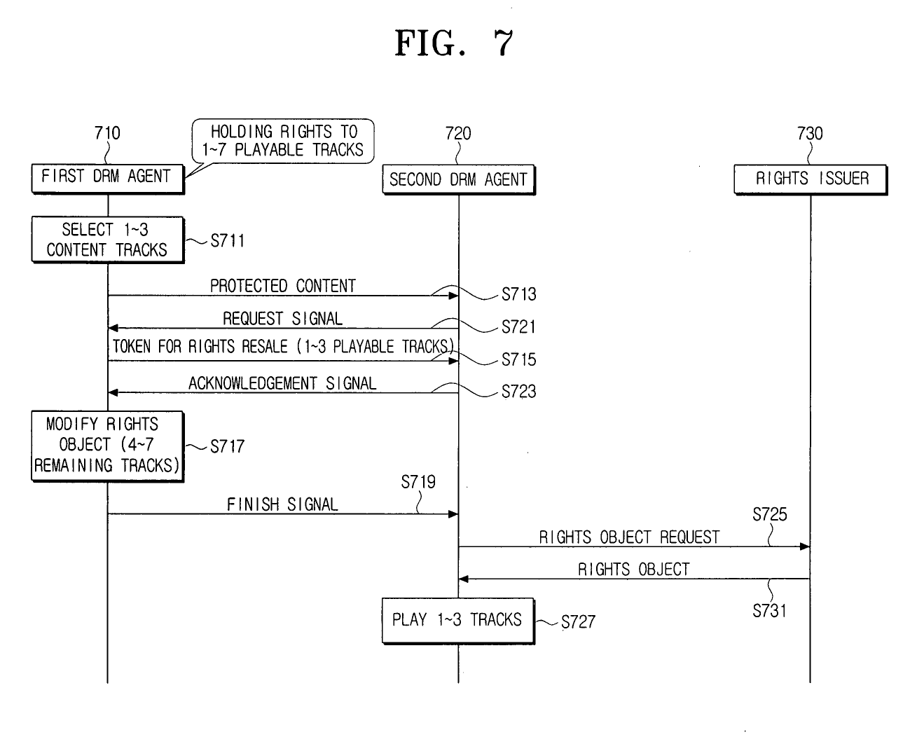

FIG. 7 is an exemplary view illustrating an example of a system to which the method of providing a rights resale function according to embodiments of the present invention is applied. In particular, a method of reselling rights in the case of transmitting a part of content will now be described with reference to FIG. 7.

First, a user who uses the first DRM agent 710, which is an example of a rights resale agent, selects content to be resold to the second DRM agent 720, which is an example of a rights acquisition agent, and the playable track numbers that are use information at step (S711). Here, the number of playbacks can be selected in the range of the rights object held by the first DRM agent 710. For example, if the first DRM agent holds rights to play track numbers 1 to 7 of the content, rights to track numbers 1 to 3 of the content can be selected as the use information.

Then, the first DRM agent 710 transmits a protected content provided from a content provider to the second DRM agent 720 at step (S713).

Then, the first DRM agent 710 receives a request signal for a token for rights resale from the second DRM agent 720 at step (S721). Here, a public key of the second DRM agent 720 may be received simultaneously with the request for the token for rights resale.

Thereafter, the first DRM agent 710 generates the token for rights resale with reference to its own rights object, and transmits the generated token to the second DRM agent 720 at step (S715). Here, the token for rights resale may be a token for reselling rights to obtain an issuance of the content related rights object from a rights issuer 730, and may comprise authentication information and the playable track numbers (e.g., track numbers 1 to 3). The authentication information may comprise a public key held by the first DRM agent 710, a public key of the second DRM agent, a nonce, a transaction ID, and so forth. Also, the token for rights resale may further comprise values obtained by signing the authentication information and the number of playbacks with a private key held by the first DRM agent 710.

Then, the first DRM agent 710 receives an acknowledgement (ACK) signal acknowledging the reception of the token for rights resale from the second DRM agent 720 at step (S723). Here, the nonce transmitted as the token for they rights resale may be signed with a private key of the second DRM agent 720 and transmitted simultaneously with the ACK signal.

Then, the first DRM agent 710 modifies the rights object stored therein at step (S717). For example, the first DRM agent may modify the rights object from playback of the track numbers 1 to 7 of the content, to playback of the track numbers 4 to 7.

Then, the first DRM agent 710 transmits a finish signal to the second DRM agent 720 at step (S719). Here, the value of the nonce, which has been signed with the private key of the second DRM agent 720, may be signed again with a private key of the first DRM agent 710 and transmitted simultaneously with the finish signal.

Thereafter, the second DRM agent 720 transmits the token for rights resale and a rights object request signal to the rights issuer 730 at step (S725). Here, the second DRM agent 720 may receive values obtained by signing the nonce, which had been received together with the finish signal from the first DRM agent 710, with the private key of the second DRM agent 720 and then signing the signed nonce again with the private key of the first DRM agent 710.

Then, the second DRM agent 720 receives the rights object according to the token for rights resale from the rights issuer 730 at step (S731).

Then, the second DRM agent 720 releases the locking state of the protected content that has been received from the first DRM agent 710 according to the rights object received from the rights issuer 730, and then plays the track numbers 1 to 3 of the content at step (S727).

Exemplary embodiments of the present invention can be written as codes/instructions/programs and can be implemented in general-use devices that execute the codes/instructions/programs using a computer-readable recording medium. Examples of the computer-readable recording medium comprise magnetic storage media (e.g., ROM, floppy disks, hard disks, etc.), optical recording media (e.g., CD-ROMs, or DVDs), and storage media such as carrier waves (e.g., transmission through the Internet). The computer-readable recording medium can also be distributed over network coupled computer systems so that the computer-readable code is stored and executed in a distributed fashion. Also, functional programs, codes, and code segments for accomplishing embodiments of the present invention can be easily construed by programmers skilled in the art to which the present invention pertains.

As described above, according to embodiments of the present invention, the rights object to execute content can be freely transferred and shared among users on the intervention of a rights issuer, without passing through a complicated process of using the content in the related art.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An apparatus for providing a rights resale function applied to a system that comprises a rights acquisition agent and a rights issuer, the apparatus comprising:
a storage unit for storing a content related rights object;
a token generation unit for generating a token for rights resale, with reference to the rights object from the storage unit; and
a transmission/reception unit for transmitting the token for rights resale from the token generation unit to the rights acquisition agent, wherein the transmission/reception unit is configured to transmit the token for rights resale through a local limited channel.

2. The apparatus of claim 1, wherein the token for rights resale comprises a token for reselling rights to obtain an issuance of the content related rights object from the rights issuer.

3. The apparatus of claim 1, further comprising a control unit for modifying the rights object stored in the storage unit with reference to the token for rights resale as the transmission/reception unit transmits the token for rights resale.

4. (canceled)

5. The apparatus of claim 1, wherein the token for rights resale comprises authentication information and use information.

6. The apparatus of claim 5, wherein the authentication information comprises a public key held by the apparatus for providing a rights resale function and a public key of the rights acquisition agent.

7. The apparatus of claim 6, wherein the authentication information further comprises a transaction ID.

8. The apparatus of claim 7, wherein the token for rights resale further comprises values obtained by signing the authentication information and the use information with a private key held by the apparatus for providing a rights resale function.

9. A method of providing a rights resale function applied to a system that comprises a rights resale agent, a rights acquisition agent, and a rights issuer, the method comprising:
generating a token for rights resale, with reference to a rights object from the rights resale agent; and
transmitting the token for rights resale to the rights acquisition agent, wherein the transmission step comprises transmitting the token for rights resale through a local limited channel.

10. The method of claim 9, wherein the token for rights resale comprises a token for reselling rights to obtain an issuance of a content related rights object from the rights issuer.

11. The method of claim 9, further comprising modifying the rights object with reference to the token for rights resale.

12. (canceled)

13. The method of claim 9, wherein the token for rights resale comprises authentication information and use information.

14. The method of claim 13, wherein the authentication information comprises a public key held by the rights resale agent and a public key of the rights acquisition agent.

15. The method of claim 14, wherein the authentication information further comprises a transaction ID.

16. The method of claim 15, wherein the token for rights resale further comprises values obtained by signing the authentication information and the use information with a private key held by the rights resale agent.

17. A method of providing a rights resale function applied to a system that comprises a rights resale agent, a rights acquisition agent, and a rights issuer, the method comprising:
receiving protected content and a token for rights resale from the rights resale agent, wherein the step of receiving the token for rights resale comprises receiving the token for rights resale through a local limited channel;
requesting a rights object to the rights issuer by using the token for rights resale;
receiving the rights object from the rights issuer; and
releasing a locking state of the protected content by using the received rights object.

18. (canceled)

19. The method of claim 17, wherein the token for rights resale comprises authentication information and use information.

20. The method of claim 19, wherein the authentication information comprises a public key held by the rights resale agent and a public key of the rights acquisition agent.

21. The method of claim 20, wherein the authentication information further comprises a transaction ID.

22. The method of claim 21, wherein the token for rights resale further comprises values obtained by signing the authentication information and the use information with a private key held by the rights resale agent.

23. The method of claim 19, further comprising playing the content of which the locking state is released according to the use information.

24. A computer-readable recording medium having stored thereon instructions for providing a rights resale function in a system that comprises a rights acquisition agent and a rights issuer, comprising:
a first set of instructions for controlling a storage unit to store a content related rights object;
a second set of instructions for controlling a token generation unit to generate a token for rights resale, with reference to the rights object from the storage unit; and
a third set of instructions for controlling a transmission/reception unit to transmit the token for rights resale from the token generation unit to the rights acquisition agent, wherein the third set of instructions further controls the transmission/reception unit to transmit the token for rights resale through a local limited channel.

25. The computer-readable recording medium of claim 24, wherein the token for rights resale comprises a token for reselling rights to obtain an issuance of the content related rights object from the rights issuer.

26. The computer-readable recording medium of claim 24, further comprising a fourth set of instructions for controlling a control unit to modify the rights object stored in the storage unit with reference to the token for rights resale as the transmission/reception unit transmits the token for rights resale.

27. (canceled)
